(19) United States
(12) Patent Application Publication
(10) Pub. No.: US 2007/0010397 A1
(43) Pub. Date: Jan. 11, 2007

(54) Safeners and their application

(76) Inventors: Toshio Goto, Oyama-shi, Tochigi (JP); Shinichi Shirakura, Tochigi (JP); Teruyuki Ichihara, Tochigi (JP); Lutz Assmann, Langenfeld (DE); Rolf Pontzen, Leichlingen (DE)

Correspondence Address: William F Lawrence;Frommer Lawrence & Haug, 745 Fifth Avenue, New York, NY, 10151, US

(21) Appl. No.: 10/557,502

(22) PCT Filed: May 11, 2004
(86) PCT No.: PCT/EP04/05019

§ 371 Date: Nov. 21, 2005

(30) Foreign Application Priority Data
May 23, 2003 (JP) 2003-146004

(51) Int. Cl. A01N 25/32

(52) U.S. Cl. 504/106

(57) ABSTRACT

Safeners containing isothiazolecarboxamides as effective component and herbicidal compositions with reduced phytotoxicity containing said safeners and herbicidal components as effective components, wherein the safeners are represented by the Formula (I):

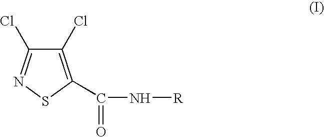

The present invention relates to new safeners and their application. More specifically the present invention relates to safeners containing isothiazolecarboxamides as the effective component and herbicidal compositions showing reduced phytotoxicity comprising said safeners and various known herbicidal compounds.

It has been already known that isothiazolecarboxamides have plant pest controlling activities (cf, for example, Japanese Laid-open Patent Publication No. 2001-522840).

In crop cultivation, weed control is very important and similar in importance compared with pest control. It is an essential condition for commercial crop production. But it is well known that many of the existing herbicidal active compounds show, due to various characteristics that such compounds possess, undesired physiological action to crops such as growth inhibition to some extent, so-called phytotoxicity. A safener is a compound which is capable of decreasing such crop damage of a herbicide and thereby increasing the crop compatibility of the herbicide.

Therefore, in the development of herbicides a countermeasure to prevent phytotoxicity is an important subject.

According to the present invention it has been found that the isothiazolecarboxamides represented by the following formula (I) set forth in the Japanese Laid-open Patent Publication No. 2001-522840 show an ability to reduce phytotoxicity of herbicidal compounds.

Thus, the present invention provides new safeners containing isothiazolecarboxamides represented by the formula 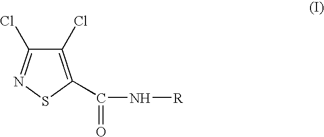
wherein
R represents a group of the formula 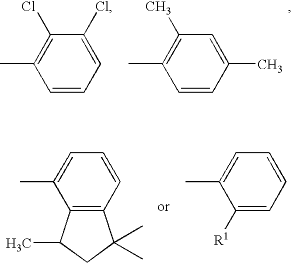
   in which
R¹ represents cyano, phenyl or cycloalkyl having 3-7 carbon atoms,
or
R represents a group of the formula 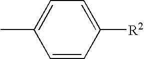
   in which
R² represents —C(CH₃)₃, —CH(C₂H₅)₂, —CH(CH₃)C2H₅, cycloalkyl having 3-7 carbon atoms or —CH₂-S-R³ (in which R³ represents alkyl having 1-6 carbon atoms or phenyl which may be optionally substituted with halogen and/or alkyl having 1-6 carbon atoms),
or
R represents a group of the formula 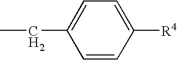
   in which
R⁴ represents hydrogen or N,N-dialkylanomethyl having 1-4 carbon atoms in each alkyl part,
or
R represents a group of the formula 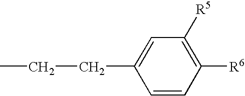
   in which
R⁵ represents hydrogen or alkoxy having 1-4 carbon atoms, and
R⁶ represents alkoxy having 1-4 carbon atoms, allyl having 1-6 carbon atoms, phenyl which may be optionally substituted with halogen or phenoxy which may be optionally substituted with halogen,
or
R⁵ represents phenoxy which may be optionally substituted with halogen, and
R⁶ represents hydrogen,
or
R represents a group of the formula 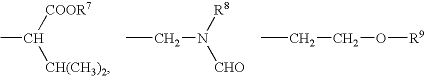
   in which
R⁷ represents alkyl having 1-4 carbon atoms,
R⁸ represents alkyl having 1-4 carbon atoms, and
R⁹ represents hydrogen or group of the formula 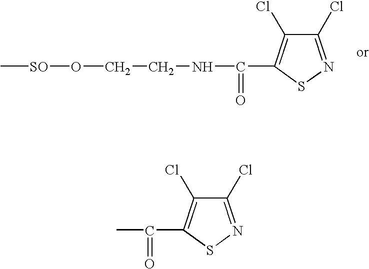
   or
R represents a group of the formula 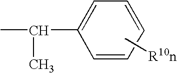
   in which
R¹⁰ represents halogen, alkyl having 1-4 carbon atoms or alkoxy having 14 carbon atoms, and
n is an integer of 0-3,
as effective component.

The present invention is therefore directed to the new use of the known compounds according to formula (I) and a method of using them as safeners.

The isothiazolecarboxamides according to the above-mentioned formula (I) may be applied together with herbicidal compounds having various modes of action, for example, herbicidal compounds having a mode of action such as acetolactate synthase inhibiting action, photosynthesis electron transport system II inhibiting action, p-hydroxyphenyl pyruvate dioxygenase inhibiting action, very long-chain fatty acid biosynthesis inhibiting action, lipid synthesis inhibiting action, protoporphyrinogen oxidase inhibiting action, gibberellin biosynthesis inhibiting action, acetyl CoA carboxylase inhibiting action, glutamine synthetase inhibiting action, 5-enolpyruvylshilimate 3-phosphate synthetase inhibiting action, auxin-like action, phytoene desaturase inhibiting action, cell destructive action by active oxygen generated in a living body, cell mitosis inhibiting action, cellulose bio-synthesis inhibiting action, etc. to express an effect of reducing phytotoxicity against crops that these herbicidal compounds show.

The present invention, therefore, also provides herbicidal compositions showing reduced phytotoxicity containing the isothiazolecarboxamides of the aforementioned formula (I) and the above-mentioned herbicidal compounds having various modes of action as effective components.

According to the present invention, it was found that the isothiazolecarboxamides according to the aforementioned formula (I), that had been known as compounds having plant pest controlling activities, unexpectedly and surprisingly show an action to reduce phytotoxicity of herbicidal compounds against crops plants and have such a very useful effect as to enable application of herbicides in the crop cultivation regions in which such application was difficult, by applying them together with herbicidal compounds.

As specific examples of the isothiazolecarboxamides of the aforementioned formula (I) the following can be mentioned:

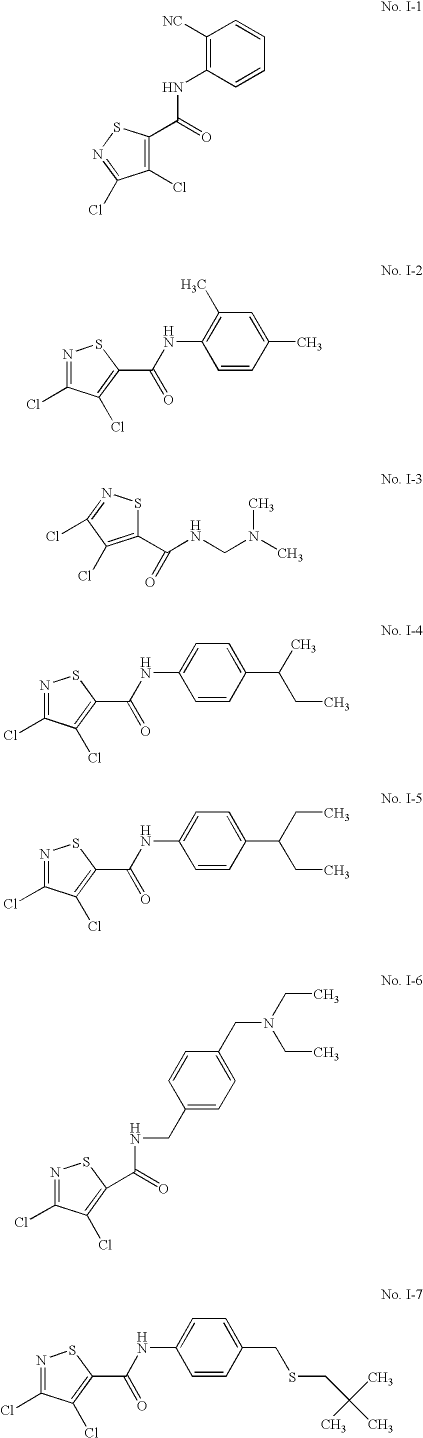

The safeners of the present invention can reduce phytotoxicity of herbicidal compounds, whose phytotoxicity is expected to be controlled, by being used together with said herbicidal compounds.

As specific examples of herbicidal compounds with various modes of action, that can be used together with the isothiazolecarboxamides according to the aforementioned formula (I) of the present invention, there can be mentioned the following.
Herbicidal compounds having acetolactate syntase inhibiting action: pyrazolsulfuronethyl, imazosulfuron, ethoxysulfuron, cyclosulfamuron, azimsulfuron, primisulfuron, prosulfuron, rimsulfuron, halosulfuron, nicosulfuron, thifensulfuron, tritosulfuron, foramsulfuron, amidosulfuron, bensulfuron-methyl, chlorsulfuron, iodosulfuron, metsulfuron-methyl, solfosulfuron, flazasulfuron, chlorimuron-ethyl, triflusulfuronmethyl, oxasulfuron, sulfometuron-methyl, trifloxysulfuron-sodium, flupyrsulfuron-methyl-sodium, imazamox, inazethapyr, imazaquin, imazapyr, imazapic, flucarbazone-sodium, propoxycarbazone-sodium, bispyribac-sodium, pyriftalid, pyrithiobac-sodium, KUH 021, pyriminobac-methyl, flumetsulam, penoxsulam, metosulam, etc.
(2) Herbicidal compounds having photosynthesis electron transport system II inhibiting action:
   pyridate, pyridafol, atrazine, terbuthylazine, simazine, terbutrnn, bromoxynil, ioxynil, metribuzin, bentazone, propanil, lenacil, bromacil, desmedipham, phenmedipham, metaintron, simetryn, prometryn, dimethametryn, diuron, isouron, linuron, siduron, chlorotoluron, etc.
(3) Herbicidal compounds having p-hydroxyphenyl pyruvate dioxygenase.inhibiting action:
   benzobicyclon, benzofenap, pyrazoxifen, pyrazolate, isoxaflutole, isoxachlortole, mesotrione, sulcotrione, a compound selected from the chemical class of benzoyl-hexadiones, etc.
(4) Herbicidal compounds having very long-chain fatty acid biosynthesis inhibiting action:
   butachlor, pretilachlor, thenylchlor, mefenacet, flufenacet, fentrazamide, cafenstrole, indanofan, piperophos, anilofos, metolachlor, metazachlor, alachlor, propachlor, dimethenamid, acetochlor, napropamide, etc.
(5) Herbicidal compounds of lipid synthesis inhibiting action:
   molinate, thiobencarb, ethofumesate, benfuresate, esprocarb, prosulfocarb, dalapon, butyrate, etc.
(6) Herbicidal compounds having protoporphyrinogen oxidase inhibiting action: pentoxazone, oxadiazon, oxadiargyl, pyrazogyl, oxyfluorfen, acifluorfen, bifenox, pyraflufen-ethyl, fluazolate, fluthiacet-methyl, butafenacil, benzfendizone, carfentrazone, sulfentrazone, flumioxazin, aclonifen, flumiclorac, etc.
(7) Herbicidal compounds having gibberellin biosynthesis inhibiting action: prohexadinone etc.
(8) Herbicidal compounds having acetyl CoA carboxylase inhibiting action: sethoxydim, alloxydim, cresodim, tepraloxydim, fenoxaprop-P-ethyl, diclofop-methyl, fluazifop-P-butyl, quizalofop-P-ethyl, etc.
(9) Herbicidal compounds having glutamine synthetase inhibiting action: glyphosate, bialaphos, etc.
(10) Herbicidal compounds having 5-enolpyruvylshikimate 3-phosphate synthetase inhibiting action:
   glufosinate, sulfosate, etc.
(11) Herbicidal compounds having auxin-like action:
   dicamba, quinclorac, picloram, triclopyr, clomeprop,, MCPB, MCPA, mecoprop, dichlorprop, 2,4-D, etc.
(12) Herbicidal compounds having phytoene desaturase inhibiting action: flurtamone, picolinafen, fluridone, norflurazon, diflufenican, beflubutamid, fluorochloridone, etc.
(13) Herbicidal compounds having cell destructive action by active oxygen generated in a living body:
   paraquat etc.
(14) Herbicidal compounds having cell mitosis inhibiting action:
   pendimethalin, butamifos, trifluralin, thiazopyr, dithiopyr, amiprophos-methyl, etc.
(15) Herbicidal compounds having cellulose bio-synthesis inhibiting action:
   isoxaben, dichlobenil, flupoxam, chlorthiamid, etc.
(16) Further, as herbicidal compounds having unidentified physiological activities inhibiting action there can be mentioned, for example, fluthiamid, bromobutide, dymron, pelargonic acid, oxaziclomefone, clomazone, etc.

These herbicidal compounds (described in generic name or derivative name) are mostly described in, for example, The Pesticide Manual, 12^{th} edition (published by British Crop Protection Council in 2000), or already well known.

Further, benzoylcyclohexadiones are the compounds described in publications such as WO 98/29406, WO 00/21924, WO 01/07422, etc.

In the herbicidal compositions showing reduced phytotoxicity of the present invention, the mixing ratio of the isothiazolecarboxamides of the formula (I) and herbicidal compounds can be varied in a relatively wide range according to the kinds of herbicidal compounds, time of application, region of application, way of application, etc. of said compositions.. They can be applied in the ratio of generally 0.001-10 parts by weight, preferably 0.01-5 parts by weight of herbicidal compounds for 1 part by weight of the isothiazolecarboxamides of the formula (I).

The most favorable feature of the herbicidal compositions showing reduced phytotoxicity of the present invention is the ability to cause selective herbicidal action among crops and weeds. And due to such selective herbicidal action said compositions of the present invention can be used in connection with the following plants.

Genera of the dicotyledonous weeds: Sinapis, Leipidium, Galium, Stellaria, Chenopodium, Urtica, Senecio, Amaranthus, Portulaca, Xanthium, Ipomoea, Polygonum, Ambrosia, Cirsium, Sonchus, Solanum, Rorippa, Lamium, Veronica, Datura, Viola, Galeopsis, Papaver, Centaurea, Galinsoga, Rotala, Lindernia etc.

Genera of the dicotyledonous cultures: Gossypium, Glycine, Beta, Daucus, Phaseolus, Pisum, Solanum, Linum, Ipomoea, Vicia, Nicotiana, Lycopersicon, Arachis, Brassica, Lactica, Cucumis, Cucurbita etc.

Genera of the monocotyledonous weeds: Echinochloa, Setaria, Panicum, Digitaria, Phleum, Poa, Festuca, Eleusine, Lolium, Bromus, Avena, Cyperus, Sorghum, Agropyron, Monochoria, Fimbristylis, Sagittaria, Eleocharis, Scirpus, Paspalum, Ischaemum, Agrostis, Alopecurus, Cynodon etc.

Genera of the monocotyledonous cultures. Oryza, Zea, Triticum, Hordeum, Avena, Secale, Sorghum, Panicum, Saccharum, Ananas, Asparagus, Allium etc.

Moreover, said compositions of the present invention can be applied, not being restricted to the above-mentioned plants, in connection with other plants in a similar manner.

Further, said compositions of the present invention can be used for controlling weeds in perennial plant cultures and can be applied, for example, in afforestations, decorative tree plantings, orchards, vineyards, citrus groves, nut orchards, banana plantations, coffee plantations, tea plantations, rubber plantations, oil palm plantations, cocoa plantations, soft fruit plantings, hop fields etc. Further, they can be applied for the selective weed control in annual plant cultures.

Said compositions of the present invention can be made into customary formulation forms when being applied for controlling weeds. As such formulation forms there can be mentioned, for example, solutions, emulsions, wettable powders, suspensions, powders, soluble powders, granules, suspo-emulsion concentrates, solid formulations Gumbo formulations), floating granules, microcapsules in polymer substance, etc.

These formulations can be prepared according to per se known methods. The formulations according to the present invention can be prepared, for example, by mixing the compounds of the aforementioned formula (I) and herbicidal compounds with extenders, namely liquid diluents and/or solid diluents, and optionally using surfactants, namely emulsifiers and/or dispersants and/or foam-forming agents.

When water is used as extender, for example, organic solvents can be used as auxiliary solvents. As liquid diluents there can be mentioned organic solvents, for example, aromatic hydrocarbons (for example, xylene, toluene, alkylnaphthalene, etc.), chlorinated aromatic or chlorinated aliphatic hydrocarbons (for example, chlorobenzenes, ethylene chlorides, methylene chloride, etc.), aliphatic hydrocarbons [for example, cyclohexane etc. or paraffins (for example, mineral oil fractions, mineral and vegetable oils, etc.)], alcohols (for example, butanol, glycols, and their ethers, esters, etc.), ketones (for example, acetone, methyl ethyl ketone, methyl isobutyl ketone, cyclohexanone, etc.), strongly polar solvents (for example, dimethylformamide, dimethyl sulfoxide, etc.), etc. and water.

As solid diluents there can be mentioned, for example, ammonium salts and ground natural minerals (for example, kaolin, clay, talc, chalk, quartz, attapulgite, montmorillonite, diatomaceous earth, etc.), ground synthetic minerals (for example, highly dispersed silicic acid, alumina, silicates etc.) etc. As solid carriers for granules there can be used, for example, crushed and fractionated rocks (for example, calcite, marble, pumice, sepiolite, dolomite, etc.) synthetic granules of inorganic and organic meals, particles of organic materials (for example, saw dust, coconut shells, maize cobs, tobacco stalks, etc.) etc.

As emulsifiers and/or foam-forming agents there can be mentioned, for example, nonionic and anionic emulsifiers [for example, polyoxyethylene fatty acid esters, polyoxyethylene fatty acid alcohol ethers (for example, alkylaryl polyglycol ethers, alkylsulfonates, alkylsulfates, arylsulfonates etc.)], albumin hydrolysis products, etc.

As dispersants, for example, lignin sulfite waste liquor and methyl cellulose are adequate.

Tackifiers can also be used in formulations (powders, granules, emulsifiable concentrates). As said tackifiers there can be mentioned, for example, carboxymethyl cellulose, natural and synthetic polymers (for example, gum Arabic, polyvinyl alcohol, polyvinyl acetate, etc.), natural phospholipids (for example, cephalins and recithins), synthetic phospholipids, etc. Further, mineral oils and vegetable oils can be used as additives.

Colorants can also be used. As said colorants there can be mentioned inorganic pigments (for example, iron oxide, titanium oxide, Prussian Blue, etc.), organic dyestuffs such as alizarin dyestuffs, azo dyestuffs or metal phthalocyanine dyestuffs, and further traces nutrients such as salts of iron, manganese, boron, copper, cobalt, molybdenum and zinc, etc..

The formulations can contain the total of component (a) and component (b) at the concentration of generally 0.1-95 % by weight, preferably 0.5-90 % by weight

The compositions of the present invention can be used for weed control as themselves or in..their formulation forms. It is possible to do tank mixing when they are used, and further to mix with other known active compounds, particularly active compounds that are generally used, for example, fingicides, insecticides, plant growth regulators, plant nutrients, soil improving agents, fertilizers, etc.

The compositions of the present invention can be directly used as such or in their formulation forms or in application forms prepared by further diluting said formulations, for example, ready-to-use solutions, emulsifiable concentrates, suspensions, powders, wettable powders or granules. These formulation forms can be applied to rice paddy by usual methods, for example, watering, spraying, atomizing, dusting, granule application, etc.

The applicable amount of said compositions in the present invention can be varied in a substantial range. The application amount can be, as total amount of the compounds of the formula (I) and herbicidal compounds, f6r example, in the range of 0.01-10kg/ha, preferably 0.5-5 kg/ha.

Excellent effects of the compositions by the present invention will be described more specifically by the following examples. The present invention, however, should not be restricted to them in any way.

### EXAMPLES

Biological Test Examples and Formulation Examples

(Test compounds)

Safeners: The aforementioned compounds No.I-1 No. I-2, No.I-3, No.I4, No.I-5, No.I-6 and No.I-7.

Herbicidal compounds: 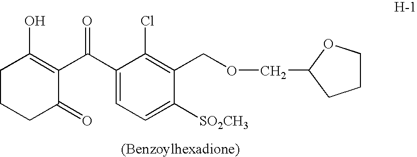
H-2 Bensuiliron-methyl

H-3 Fenoxaprop-P-ethyl

Preparation of Test Solution

Carrier: Acetone 5 parts by weight

Surfactant: Benzyloxy polyglycol ether 1 part by weight

A prescribed amount of the test solution is prepared by diluting with water the formulation obtained by mixing the above-mentioned carrier and surfactant with 1 part by weight of the active compounds (safeners and herbicidal compounds).

Test Example 1: Test for Safening Effect against Phytotoxicity of Herbicidal Compounds against Wheat

(Method)

Seeds of wheat (variety: Norin No.61) were sown on absorbent cotton in a dish, containing the previously prepared, diluted solution with the prescribed concentration of the test compounds, and grown in a climate chamber. After 5 days the degree of phytotoxicity, particularly bleaching state, was observed and evaluated in 0-100%.

0% =No phytotoxicity

100% =Complete bleaching or withering state

Test results were evaluated by Colby's equation. Colby's equation:

$$E = X + \frac{Y \times ( 100 - X )}{100}$$

E: Expected value of phytotoxicity by mixing

X: Measured value of phytotoxicity by one active compound
Y: Measured value of phytotoxicity by the other active compound
   Table 1

(Reults)

TABLE 1

| | Phytotoxicity % | | | Expected value E |
|---|---|---|---|---|
| | Amount of effective | H-1 | | by Colby's equation |
| Compound | component ppm | 0 | 10 | (Phytotoxicity %) |
| No. I-1 | 0 | | 50 | |
| | 10 | 0 | 20 | 50 |
| | 50 | 0 | 20 | 50 |
| No. I-2 | 10 | 0 | 30 | 50 |
| | 50 | 0 | 10 | 50 |
| No. I-3 | 10 | 0 | 5 | 50 |
| | 50 | 0 | 0 | 50 |
| No. I-4 | 10 | 0 | 10 | 50 |
| | 50 | 0 | 5 | 50 |
| No. I-5 | 10 | 0 | 30 | 50 |
| | 50 | 0 | 10 | 50 |
| No. I-6 | 10 | 0 | 15 | 50 |
| | 50 | 0 | 15 | 50 |
| No. I-7 | 10 | 0 | 30 | 50 |
| | 50 | 0 | 20 | 50 |

Test Example 2: Test for Safening Effect against Phytotoxicity of Herbicidal Compounds against Paddy Rice
(Method)

Two seedlings of paddy rice (variety: Nipponbare) of 2.5 leaf stage were transplanted in a plastic pot under submerged conditions with a trnsplantation depth of 0 cm. A diluted solution with the prescribed concentration of the 4% granules of the compound No. I-1 and herbicidal compounds were applied on the water surface. Three weeks after the application the degree of phytotoxicity was observed and evaluated in 0-100%.

0%=No phytotoxicity

100%=Complete withering state

Table 2

(Results)

TABLE 2

| | Phytotoxicity (%) | | | Expected value E by |
|---|---|---|---|---|
| | Amount of effective | No. I-1 | | Colby's equation |
| Compound | component kg/ha | 0 | 1 | (Phytotoxicity %) |
| | 0 | | 0 | |
| H-1 | 0.6 | 30 | 10 | 30 |
| H-2 | 0.15 | 40 | 20 | 40 |
| H-3 | 0.1 | 70 | 40 | 70 |

### Formulation Example 1

To a mixture of 7 parts by weight of the compound No. I-1, 2 parts by weight of the compound H-1, 30 parts by weight of bentonite (montmorfllonite), 58 parts by weight of talc and 3 parts by weight of ligninsulfonate salt, 25 parts by weight of water were added, well kneaded, made into granules of 1040 mesh with an extrusion granulator and dried at 40-50° C. to obtain granules.

### Formulation Example 2

96 Parts by weight of clay mineral particles having a particle diameter distribution in the range of 0.2-2mm are put in a rotary mixer. While rotating it, 3.6 parts by weight of the compound No. I-1 and 0.4 parts by weight of bensulfiuron are sprayed together with a liquid diluent. The mixture is wetted uniformly and dried at 40-50° C. to obtain granules.

### Formulation Example 3

A mixture of 6.5 parts by weight of the compound No. I-1, 1.5 parts by weight of the compound H-1, 10 parts by weight of ethylene glycol, 3 parts by weight of polyoxyalkylene tristyrylphenyl ether, 10 parts by weight of xanthan gum, 0.5 parts by weight of 14% silicone oil emulsion and 68.5 parts by weight of water was well stirred and then crushed with a crusher (Dyno-Mill Type KDL) to obtain water suspension formulation.

### Formulation Example 4

18 Parts by weight of the compound No. I-1, 2 parts by weight of fenoxaprop-P-ethyl, 30 parts by weight of sodium ligninsulfonate, 15 parts by weight of bentonite and 35 parts by weight of calcined diatomaceous earth powder were sufficiently- mixed and, after addition of water, well kneaded, extruded using a 0.3 mm screen and dried to obtain water-dispersible granules.

1. A method of using an isothiazolecarboxamide according to the general formula (I) 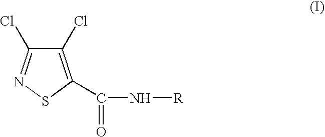
wherein
R represents a group of the formula 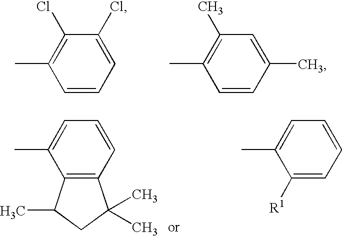
in which
R¹ represents cyano, phenyl or cycloalkyl having 3-7 carbon atoms, or
R represents a group of the formula 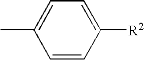
in which
R² represents —C(CH₃)₃, —CH(C₂H₅)₂, —CH(CH₃)C₂H₅, cycloalkyl having 3-7 carbon atoms or —CH₂-S-R³ (in which R³ represents alkyl having 1-6 carbon atoms or phenyl which may be optionally substituted with halogen and/or alkyl having 16 carbon atoms),
or
R represents a group of the formula 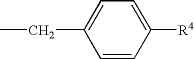
in which
R⁴ represents hydrogen or N,N-dialkylaminomethyl having 14 carbon atoms in each alkyl part,
or
R represents a group of the formula 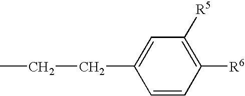
in which
R⁵ represents hydrogen or alkoxy having 1-4 carbon atoms, and
R⁶ represents alkoxy having 14 carbon atoms, alkyl having 1-6 carbon atoms, phenyl which may be optionally substituted with halogen or phenoxy which may be optionally substituted with halogen,
or
R⁵ represents phenoxy which may be optionally substituted with halogen, and
R⁶ represents hydrogen,
or
R represents a group of the formula 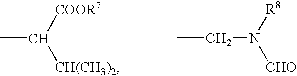
or —CH₂—CH₂—O—R9 in which
R⁷ represents alkyl having 1-4 carbon atoms,
R⁸ represents alkyl having 1-4 carbon atoms, and
R⁹ represents hydrogen or group of the formula 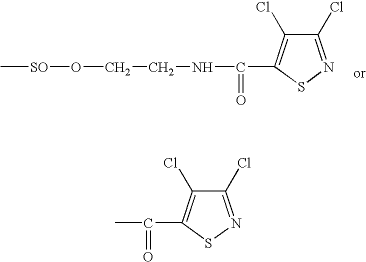
or
R represents a group of the formula 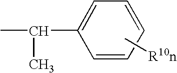
in which
R¹⁰ represents halogen, alkyl having 1-4 carbon atoms or alkoxy having 1-4 carbon atoms, and
n is an integer of 0-3,
as a safener.

2. Use of an isothiazolecarboxamide according to formula (I) set forth in claim 1 as a safener.

3. Herbicidal compositions comprising
(a) an isothiazolecarboxamide according to formula (I) set forth in claim 1 and
(b) at least one herbicidal compound selected from the group consisting of herbicidal compounds having acetolactate synthase inhibiting action,
herbicidal compounds having photosynthesis electron transport system II inhibiting action,
herbicidal compounds having p-hydroxyphenyl pyruvate dioxygenase inhibiting action,
herbicidal compounds having very long-chain fatty acid biosynthesis inhibiting action,
herbicidal compounds having lipid synthesis inhibiting action,
herbicidal compounds having protoporphyrinogen oxidase inhibiting action,
herbicidal compounds having gibberellin biosynthesis inhibiting action,
herbicidal compounds having acetyl CoA carboxylase inhibiting action,
herbicidal compounds having glutamine synthetase inhibiting action,
herbicidal compounds having 5-enolpyruvylshikimate 3-phosphate synthetase inhibiting action,
herbicidal compounds having auxin-like action,
herbicidal compounds having phytoene desaturase inhibiting action,
herbicidal compounds having cell destructive action by active oxygen generated in a living body,
herbicidal compounds having cell mitosis inhibiting action, and
herbicidal compounds having cellulose bio-synthesis inhibiting action.

4. Herbicidal compositions comprising
(a) an isothiazolecarboxamide according to formuia (1) set forth in claim 1 and
(b) at least one herbicidal compound selected from the group consisting of pyrazo-sulfuron-ethyl, imazosulfuron, ethoxysulfiron, cyclosulfamuron, azimsulfuron, primriron, prosuftiron, nmsulfuron, halosulron, mcosulfuron, thifensulfuron, tritosulfiuron, foramsulfuron, amidosulfuron, bensulfuron-methyl, clorsulfuron, iodosulfuron, metsuuron-methyl, suLfosuilfron, flazasulron, chlorimuron-ethyl, triflusulfiiron-methyl, oxasuffiron, sulfometuron-methyl, trifloxysulfiron-sodium, flupyrsulfiiron-methyl-sodium, imazamox, imazethapyr, imazaquin, imazapyr, imazapic, flucarbazone-sodium, propoxycarbazone-sodium, bispyribac-sodium, pyriftalid, pyrithiobac-sodium, KUH 021, pyriminobacmethyl, flumetsulam, penoxsulam, metosulam, pyridate, pyridafol, atrazine, terbuthylazine, simazine, terbutryn, bromoxynil, ioxynil, metribuzin, bentazone, propanil, lenacil, bromacil, desmedipham, phenmedipham, metamitron, simetryn, prometryn, dimethametryn, diuron, isouron, linuron, siduron, chlorotoluron, benzobicyclon, benzofenap, pyrazoxifen, pyrazolate, isoxaflutole, isoxachlortole, mesotrione, sulcotrione, benzoylhexadiones, butachlor, pretilachlor, thenylchlor, mefenacet, flufenacet, fentrazamide, cafenstrole, indanofan, piperophos, anilofos, metolachlor, metazachlor, alachlor, propachlor, dimethenamid, acetochlor, napropamide, molinate, thiobencarb, ethofumesate, benfuresate, esprocarb, prosulfocarb, dalapon, butyrate, pentoxazone, oxadiazon, oxadiargyl, pyrazogyl, oxyfluorfen, acifluorfen, bifenox, pyraflufen-ethyl, fluazolate, fluthiacet-methyl, butafenacil, benzfendizone, carfentrazone, sulfentrazone, flumioxazin, aclonifen, flumiclorac, prohexadinone, sethoxydim, alloxydim, cresodim, tepraloxydim, fenoxaprop-P-ethyl, diclofop-methyl, fluazifop-P-butyl, quizalofop-P-ethyl, glyphosate, bialaphos, glufosinate, sulfosate, dicamba, quinclorac, picloram, triclopyr, clomeprop, , MCPB, MCPA, mecoprop, dichlorprop, 2,4-D, flurtamone, picolinafen, fluridone, norflurazon, diflufenican, beflubutamid, fluorochloridone, paraquat, pendimethalin, butamifos, trifluralin, thiazopyr, dithiopyr, amiprophos-methyl, isoxaben, dichlobenil, flupoxam, chlorthiamid, fluthiamid, bromobutide, dymron, pelargonic acid, oxaziclomefone and clomazone.
